(19) United States
(12) Patent Application Publication
(10) Pub. No.: US 2012/0269298 A1
(43) Pub. Date: Oct. 25, 2012

(54) PHASE ERROR COMPENSATION ARRANGEMENT AND PHASE ERROR COMPENSATION METHOD

(75) Inventors: Christian Mazzucco, Milan (IT); Sergio Bianchi, Milan (IT)

(73) Assignee: Huawei Technologies Co., Ltd., Shenzhen (CN)

(21) Appl. No.: 13/488,155

(22) Filed: Jun. 4, 2012

Related U.S. Application Data
(63) Continuation of application No. PCT/CN2011/073109, filed on Apr. 21, 2011.

(51) Int. Cl. H04L 27/22

(52) U.S. Cl. 375/329

(57) ABSTRACT

A phase error compensation arrangement comprising a first phase error compensator and a second phase error compensator arranged downstream of the first phase error compensator. The first phase error compensator is configured to obtain a first estimated phase error ((φ_{PS}) of the receive signal based on a value of the receive signal and a predefined pilot value, to shift a phase of the receive signal by the first estimated phase error (φ_{PS}), and to provide the phase shifted receive signal to the second phase error compensator.

### CROSS REFERENCE TO RELATED APPLICATIONS

This application is a continuation of International Application No. PCT/CN2011/073109, filed on Apr. 21, 2011, which is hereby incorporated by reference in its entirety.

### TECHNICAL FIELD

The invention relates to the field of data communication and in particular to phase error compensation of a receive signal.

### BACKGROUND OF THE INVENTION

In data communication systems, signals transmitted from a transmitter to a receiver are often modulated according to one of various modulation schemes. If a demodulator in the receiver needs to recover a carrier of the receive signal, then frequency impairments between a local oscillator of the transmitter and a local oscillator of the receiver may be taken into account. For example, the impairments of frequency and phase noise of the oscillators may be estimated and mitigated by the receiver in order to improve the efficiency of reconstruction of the receive signal.

To estimate and mitigate the impairments and noise, various digital techniques may be deployed. For example, it is possible to insert known symbols among data symbols in the transmission, which are used at the receiver side to estimate phase and frequency errors. For example, such known symbols are called pilot symbols. However, if for example the oscillator is affected with increased phase noise, the performance of such technique is reduced. Furthermore, if a higher order modulation format is used, the performance of such technique may be insufficient. In order to improve the performance of the described technique, the number of pilot symbols may be increased. However, this can reduce the spectrum efficiency.

Another possible technique employs a closed loop circuit, which may include a phase-locked loop in order to refine the estimation of data symbols. However, such closed loop circuits may show a degraded performance for increasing phase noise.

### SUMMARY OF THE INVENTION

It is the object of the present invention to provide an efficient concept for compensating a phase error of a receive signal.

This object is achieved by the features of the independent claims. Further embodiments are apparent from the dependent claims.

The present invention is based on the finding that a decision-directed feed-forward structure can be used to efficiently determine a phase error of a receive signal. For example, a value, in particular a complex value of the receive signal, can be mapped onto a mapped value, for example a complex constellation point of a modulation scheme like a quadrature amplitude modulation, QAM, or the like. If there is a phase error in the receive signal, then the value of the receive signal and the mapped value differ and, together, carry an information about the phase error. By combining the value and the mapped value, for example by a complex multiplication, the phase error can be estimated or extracted from the combination result. The estimated phase error may be used to correct or compensate the receive signal.

According to a first aspect, the invention relates to a phase error compensation arrangement for compensating a phase error of a receive signal. The phase error compensation arrangement comprises a first phase error compensator and a second phase error compensator arranged downstream of the first phase error compensator. The first phase error compensator is configured to obtain a first estimated phase error of the receive signal based on a value of the receive signal and a predefined pilot value, to shift a phase of the receive signal by the first estimated phase error, and to provide the phase shifted receive signal to the second phase error compensator. The second phase error compensator comprises a delay element for delaying the phase shifted receive signal, a phase error estimator for providing a second estimated phase error of the phase shifted receive signal, and a phase shifter for shifting a phase of the delayed phase shifted receive signal by the second estimated phase error. The phase error estimator comprises a slicer for mapping a value of the phase shifted receive signal onto a mapped value, a conjugator for conjugating one of the mapped value and the value of the phase shifted receive signal to obtain a conjugated output and an unprocessed output, a multiplier for multiplying the conjugated output and the unprocessed output of the conjugator to obtain a distinction value, and a phase determiner for determining a phase of the distinction value to obtain the second estimated phase error.

Accordingly, in the phase error compensation arrangement according to the first aspect of the invention, the second phase error compensator is, for example, connected in series to the first phase error compensator. For example, a phase error of the receive signal is first compensated by rotating the receive signal, in particular a value of the receive signal by the first estimated phase error, and afterwards rotated by the second estimated phase error of the phase error estimator. In particular, the phase error estimation of the second phase error compensator is performed on the phase-shifted output signal of the first phase error compensator.

In the conjugator, a complex conjugation of one of the values is performed while the remaining value is unchanged. If the phase of the value of the receive signal and the phase of the mapped value are equal, the result of the multiplication, namely the distinction value, is a real number without an imaginary part. Hence, a zero phase error can be determined by the phase determiner. However, if the value of the receive signal and the mapped value differ in their phases, the distinction value as the result of the multiplication will have an imaginary part. The phase error of the receive signal, in particular a momentary phase error, may be determined by calculating the phase of the distinction value. Accordingly, the second phase error can be determined with little effort.

Such a phase error compensation arrangement makes it possible to correct or at least partially correct a phase error of a receive signal in order to allow, for example, a better determination of data symbols included in the receive signal. By the use of the phase error estimator included in the first aspect of the invention, the second phase error can be estimated efficiently. With the phase shifter, a rotation of the receive signal, in particular in the complex plane, is accomplished to compensate for the phase error. The second phase error compensator may also be called a feed forward phase error compensator.

According to a first implementation form of the first aspect, the invention relates to a phase error compensation arrangement, wherein the phase error estimator further includes a filter for filtering an output value of the phase determiner to obtain the estimated phase error. Hence, past output values of the phase determiner can be weighted to obtain the estimated phase error.

The filter may for example include a low-pass filter. Hence, punctual deviation of the output value can be averaged out in the estimated phase error. The filter may for example include a moving average filter. With a moving average filter, an average over a distinct number of past output values can be calculated to obtain the estimated phase error, wherein the past output values may be weighted differently. According to some implementation forms, the filter may include equal weights for the output values of the phase determiner. In these cases, the estimated phase error corresponds to a mean value of the past output values. The filter may be implemented as a finite impulse response, FIR, filter.

According to a second implementation form of the first aspect, the invention relates to a phase error compensation arrangement, wherein the phase shifter includes a complex multiplier for multiplying a value of the phase shifted delayed receive signal with an error value, the error value being determined by a complex exponential function of the second estimated phase error. The error value may for example be determined according to the formula exp(j·φ_{FF}(t)), wherein φ_{FF}(t) is a momentary value of the second estimated phase error at the time t.

According to a third implementation form of the first aspect, the invention relates to a phase error compensation arrangement, which is further configured to adapt a delay time of the delay element to a processing time of the phase error estimator. The delay time of the delay element may for example be chosen such that the receive signal is delayed until the second phase error is estimated for the momentary value of the receive signal.

According to a fourth implementation form of the first aspect, the invention relates to a phase error compensation arrangement, wherein the first phase error compensator is configured to determine phase error values upon the basis of the value of the receive signal and the predefined pilot value at given times, and to obtain the first estimated phase error by interpolating between the phase error values. The receive signal may for example include one or more pilot symbols, which are predefined, and a number of payload data symbols. The estimated phase error of the first phase error compensator may then be interpolated at the times at which payload symbols are transmitted in the receive signal by interpolating between the phase error values determined for the times at which pilot symbols are transmitted in the receive signal. The interpolation may for example be a linear interpolation or a higher order interpolation.

According to a fifth implementation form of the first aspect, the invention relates to a phase error compensation arrangement which includes a further slicer arranged downstream the second phase error compensator for a mapping a value of a signal at an input of the further slicer onto a mapped value at an output of the further slicer, and a feedback phase error compensator. The feedback phase error compensator is configured to obtain a feedback phase error upon the basis of a difference value between the value at the input of the further slicer and a mapped value at the output of the further slicer, and to shift a phase of the receive signal by the feedback phase error to obtain the signal at the input of the further slicer. Accordingly, a mapping error at the further slicer is evaluated in a feedback path to determine a phase error, namely the feedback phase error which is used to rotate the receive signal before providing it to the further slicer.

A feedback part of the feedback phase error compensator may for example be based on a phase-locked loop, PLL, scheme, wherein the phase information of the PLL is used for compensating the receive signal. The feedback phase error compensator may for example include a phase detector and a loop filter being provided with a difference value to obtain the feedback phase error. An output of the loop filter may be provided to a voltage-controlled oscillator VCO that may act as an integrator or, for a digital circuit, as an accumulator. An output of the VCO may be a phase value that is used as the feedback phase error.

According to a sixth implementation form of the first aspect, the invention relates to a phase error compensation arrangement comprising another phase error compensator being arranged in cascade with the second phase error compensator. The another phase error compensator includes another phase error estimator as described before for the phase error estimator of the second phase error compensator. Accordingly, a phase error of the receive signal can be reduced in several stages, namely the first phase error compensator, the second phase error compensator and another phase error compensator.

The another phase error compensator may for example include a delay element for delaying an input signal of the another phase error compensator, the another phase error estimator for providing another estimated phase of said input signal, and a phase shifter for shifting a phase of the delayed input signal by the another estimated phase error.

Accordingly, the another phase error estimator may comprise another slicer for mapping a value of said input signal onto a mapped value another conjugator for conjugating one of the mapped value and the value of said input signal to obtain another conjugated output and another unprocessed output, another multiplier for multiplying the another conjugated output and the another unprocessed output of the another conjugator to obtain another distinction value, and another phase determiner for determining a phase of the another distinction value to obtain the another estimated phase error.

According to a second aspect, the invention relates to a phase error compensation method for compensating a phase error of a receive signal. In the phase error compensation method, a first estimated phase error of the receive signal is obtained based on a value of the receive signal and a predefined pilot value and a phase of the receive signal is shifted by the first estimated phase error. Furthermore, a value of the phase shifted receive signal is mapped onto a mapped value. One of the mapped values and the value of the phase shifted receive signal are conjugated to obtain a conjugated output value and an unprocessed output value. The conjugated output value and the unprocessed output value are multiplied to obtain a distinction value. A phase of the distinction value is determined to obtain a second estimated phase error. The phase shifted receive signal is delayed. A phase of the delayed phase shifted receive signal is shifted by the second estimated phase error.

According to some implementation forms of the second aspect, obtaining the estimated phase error includes the filtering of the distinction value. Further, implementation forms of the second aspect arise from the various implementation forms of the first aspect of the invention.

### BRIEF DESCRIPTION OF THE DRAWINGS

Further embodiments of the invention will be described with reference to the following figures, in which:

FIG. 1 shows a phase error estimator according to an implementation form;

FIG. 2 shows a phase error compensator according to an implementation form

FIG. 3 shows a phase error compensation arrangement according to an implementation form;

FIG. 4 shows a phase error compensation arrangement according to an implementation form;

FIG. 5 shows a detail feedback phase error compensator according to an implementation form; and

FIG. 6 shows a phase error compensation arrangement according to an implementation form.

### DETAILED DESCRIPTION OF THE EMBODIMENTS

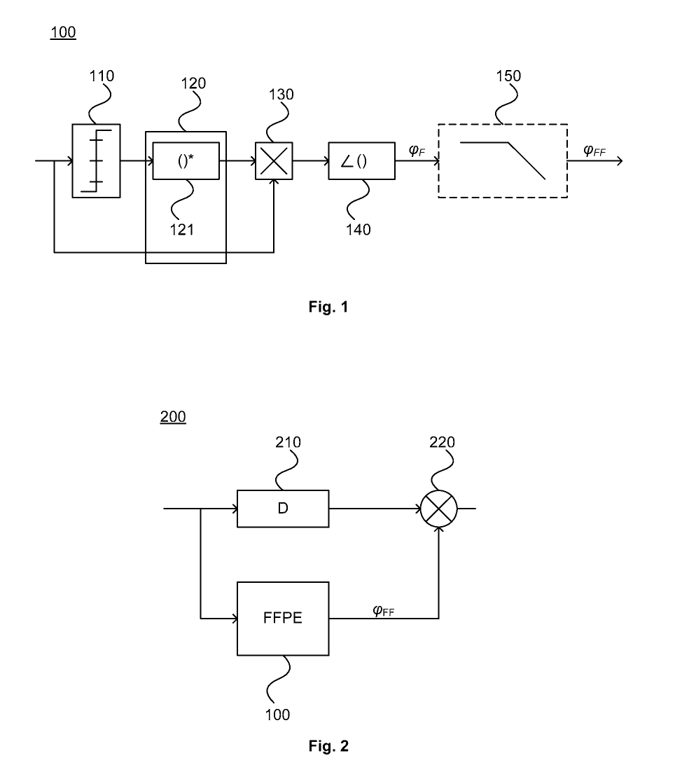

FIG. 1 shows an implementation form of a phase error estimator 100. The phase error estimator 100 comprises a slicer 110 connected to an input of the phase error estimator and a conjugator 120, which on its input side is connected to an output of the slicer 110 and to the input of the phase error estimator. The conjugator 120 includes a conjugation block 121 for performing a complex conjugation of its input signal. Outputs of the conjugator 120 are connected to a complex multiplier 130. An output of the multiplier 130 is coupled to a phase determiner 140 which has a filter 150 arranged downstream.

The slicer 110 is configured to map a value of a receive signal at its input onto a mapped value at its output. The receive signal may be a digitally sampled and down-converted radio frequency signal which can be composed of modulated symbols, for example quadrature amplitude-modulated, QAM, symbols.

For example, the slicer 110 compares the receive signal with a number of thresholds and performs a mapping onto the mapped value based on the comparison results. For example, the slicer 110 performs a two-dimensional operation in the complex plane to map a value of the receive signal to one of a predefined number of constellation points of a modulation scheme.

The output signal of the slicer 110 with the mapped value and the unprocessed receive signal with an unprocessed value are provided to the conjugator 120 which performs a complex conjugation of one of its two input signals. In the implementation form of FIG. 1, the mapped value is conjugated by the conjugation element 121, while the receive signal remains unprocessed. However, according to other implementation forms, it is also possible to perform a conjugation of the receive signal and leave the output signal of the slicer 110 unprocessed.

The outputs of the conjugator 120, namely the conjugated output and the unprocessed output, are provided to the multiplier 130 to perform a complex multiplication, which results in a distinction value being provided to the phase determiner 140. The phase determiner 140 determines the complex phase (p_{F} of the distinction value, for example according to φ_{F}=tan⁻¹(Im[H]/Re[H]),

wherein H is he complex distinction value provided by the multiplier 130.

The phase value φ_{F} is provided to the filter 150 to obtain an estimated phase error φ_{FF} of the receive signal. The filter 150 may be a moving average filter, for example an FIR filter having a low-pass transfer function. A filter length of the filter 150 may be in the order of ten filter taps. The coefficients of such an FIR filter may all be equal to achieve a standard mean value of the phase value φ_{F}, or the FIR filter may have coefficients adapted to a desired filter transfer function. An equal weighted filter may be implemented with less effort. For example, the last N phase values φ_{F} can be summed up and divided by N to obtain the estimated phase error φ_{FF}.

According to some implementation forms, the filter 150 can be left out in the phase error estimator 100. Accordingly, the phase value φ_{F} could be directly used as the estimated phase error φ_{FF}.

FIG. 2 shows an implementation of a phase error compensator 200, which comprises a delay element 210, a phase shifter 220 and a phase error estimator 100 according to an implementation form of FIG. 1. In the phase error compensator 200, the receive signal is provided to the delay element 210 for delaying the receive signal. The receive signal is further provided to the phase error estimator 100 which can also be called a feed-forward phase error estimator, FFPE, to obtain the estimated phase error φ_{FF} of the receive signal. The phase shifter 220 is configured to shift the phase of the delayed receive signal, namely the output of the delay element 210, by the estimated phase error in order to compensate a phase error in the receive signal. For example, the phase shifter 220 includes a complex multiplier for multiplying a value of the delayed receive signal with an error value. The error value may be determined by a complex exponential function of the estimated phase error φ_{FF}, for example exp(j·φ_{FF}(t)), with φ_{FF}(t) being a momentary value of the estimated phase error.

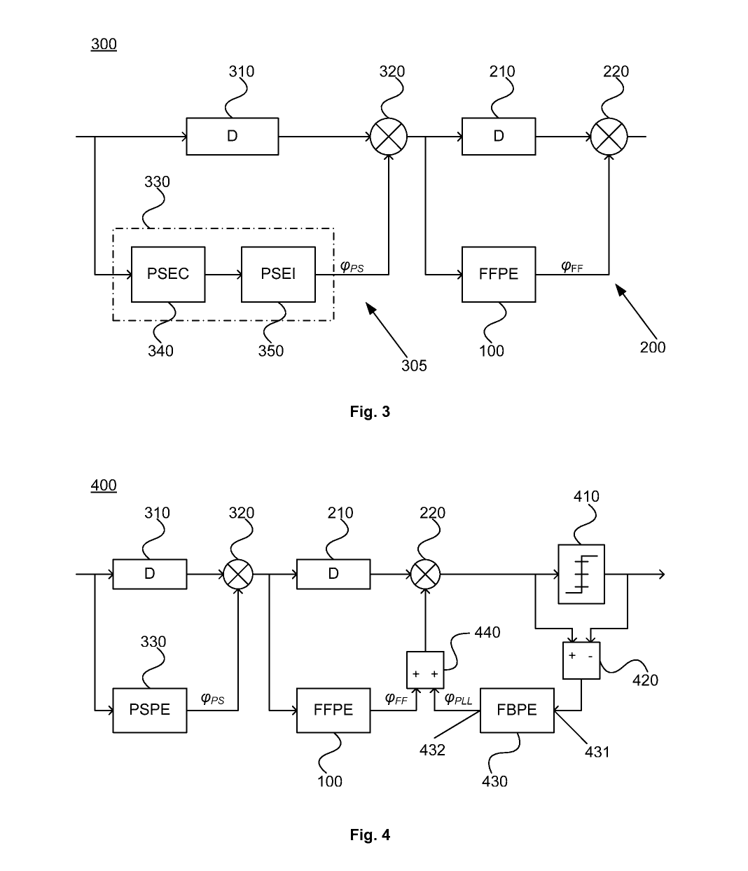

FIG. 3 shows an implementation form of a phase error compensation arrangement 300 which includes the phase error compensator 200 of FIG. 2 and a further phase error compensator 305 arranged upstream of the phase error compensator 200. The further phase error compensator 305 comprises a delay element 310, a phase shifter 320 and a pilot symbol-based phase error estimator 330. The pilot symbol-based phase error estimator, PSPE, 330 comprises a pilot symbol error calculation, PSEC, block 340 and a pilot symbol error interpolation, PSEI, block 350. The pilot symbol error calculation block 340 is able to detect predefined pilot symbols in the receive signal, which are inserted in the receive signal at given times between payload symbols, and to calculate a phase deviation between a value of the receive signal and a value of the predefined pilot symbol. For example, at given times, phase error values are determined which are provided to the pilot symbol-based phase error interpolator 350. The interpolator 350 performs an interpolation between the phase error values for the times at which no pilot symbol is present in the receive signal. Hence, a time-varying estimation of the phase error φ_{PS} is calculated by the interpolator 350 and provided to the phase shifter 320 whose function is similar or identical to the function of the phase shifter 220. Accordingly, the receive signal delayed by the delay element 310 is phase-shifted or rotated by the estimated phase error φ_{PS} and provided to the first phase error compensator 200.

FIG. 4 shows a further implementation form of a phase error compensation arrangement 400, which, for example, is based on the arrangement 300 of FIG. 3. The arrangement of FIG. 4 further comprises a further slicer 410 which is arranged downstream the phase shifter 220. An input of the further slicer 410 and an output of the further slicer 410 are provided to a difference block 420, which is coupled to a feedback phase error estimator, FBPE, 430. In particular, an output of the difference block 420 is coupled to an input 431 of the feedback phase error estimator 430. An output 432 of the feedback phase error estimator 430 is coupled to a summing block 440, whose output is coupled to the phase shifter 220.

A function of the further slicer 410 is similar to that of the slicer 110, namely mapping of a value at an input of the slicer 410 to a mapped value at an output of the slicer 410, which for example is performed based on a number of thresholds. The difference block 420 calculates the difference between the input value and the mapped value and provides it to the feedback phase error estimator 430, which for example is based on a PLL scheme. A feedback phase value φ_{PLL} is provided to the summing block 440 together with the estimated phase error φ_{FF} of the phase error estimator 100. The phase shifter 220 performs a rotation of the receive signal based on the sum of the two phase error values φ_{FF} and φ_{LL}. The blocks 420 and 430 are part of a feedback phase error compensator, which may further improve performance of the phase error compensation described before.

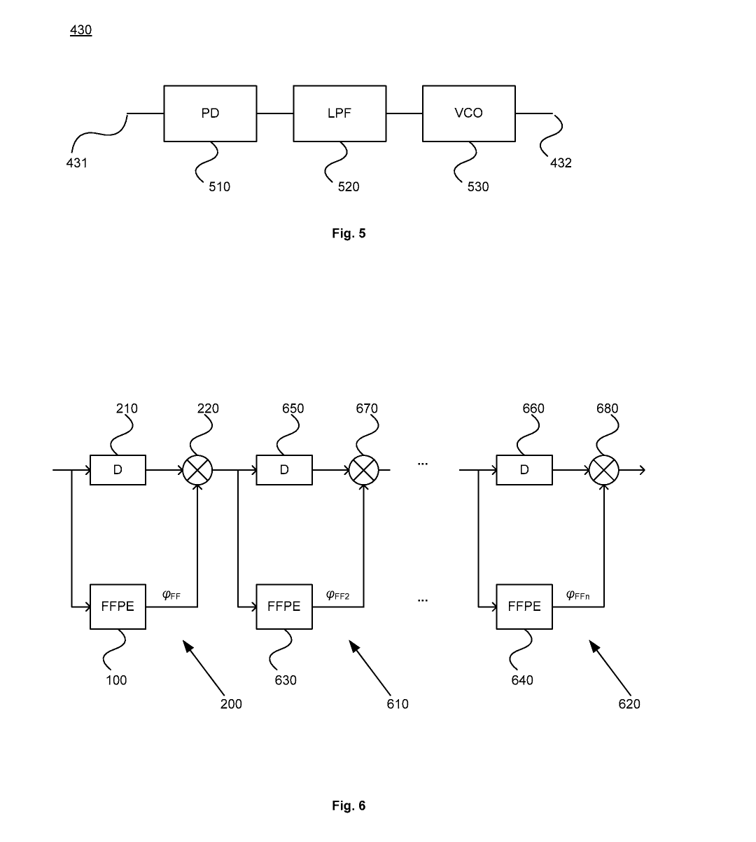

With reference to FIG. 5, the feedback phase error estimator 320 may comprise a phase detector 510, a loop filter 520 connected to an output of the phase detector 510 and a VCO 530 which is controlled by an output of the loop filter 520. In particular, a phase value of an output of the VCO 530 may be used as the feedback phase error φ_{LL} that serves as a basis for the phase-shifting in the phase shifter 220.

According to some implementation forms, the phase error compensator 200 of FIG. 2 or 3 can be replaced or extended by a cascade of two or more identical or similar compensator stages.

For example, FIG. 6 shows an implementation form of a phase error compensation arrangement in which the phase error compensator 200 is cascaded with a further phase error compensator 610 and possibly another phase error compensator 620. The phase error compensators 610, 620 may be embodied identical or similar to the phase error compensator 200. In particular, compensators 610, 620 may comprise phase error estimators 630, 640 which perform the same function as the phase error estimator 100. Accordingly, the phase error estimator 630 provides another estimated phase error φ_{FF2} and the phase error estimator 640 provides still another phase error estimate φ_{FFn}. For the compensation of the phase errors, the compensators 610, 620 comprise delay elements 650, 660 and phase shifters 670, 680.

By cascading several similar phase error compensators, in particular with feed-forward phase error estimators, a remaining phase error of a receive signal can be reduced from compensator stage to compensator stage.

According to some implementation forms, the cascade of two or more phase error compensators according to the implementation form of the phase error compensator 200 can be combined with the pilot symbol-based phase error compensator of FIG. 3 connected upstream and a feedback phase error compensator of FIG. 4 connected downstream the cascade.

However, a combination of the pilot symbol-based phase error compensator in combination with a cascade of the decision-directed feed-forward phase error compensators may provide sufficient performance in various implementation forms.

The described arrangements may be used in various radio frequency receivers or in optical receivers.

1. A phase error compensation arrangement for compensating a phase error of a receive signal, the phase error compensation arrangement comprising a first phase error compensator and a second phase error compensator arranged downstream of the first phase error compensator, wherein the first phase error compensator is configured to obtain a first estimated phase error (φ_{PS}) of the receive signal based on a value of the receive signal and a predefined pilot value, to shift a phase of the receive signal by the first estimated phase error (φ_{PS}), and to provide the phase shifted receive signal to the second phase error compensator, wherein the second phase error compensator comprises:
a delay element for delaying the phase shifted receive signal;
a phase error estimator for providing a second estimated phase error (φ_{FF}) of the phase shifted receive signal; and
a phase shifter for shifting a phase of the delayed phase shifted receive signal by the second estimated phase error (φ_{FF});
wherein the phase error estimator comprises:
a slicer for mapping a value of the phase shifted receive signal onto a mapped value;
a conjugator for conjugating one of the mapped value and the value of the phase shifted receive signal to obtain a conjugated output and an unprocessed output;
a multiplier for multiplying the conjugated output and the unprocessed output of the conjugator to obtain a distinction value; and
a phase determiner for determining a phase of the distinction value to obtain the second estimated phase error (φ_{FF}).

2. The phase error compensation arrangement of claim 1, wherein the phase error estimator further includes a filter for filtering an output value (φ_{F}) of the phase determiner to obtain the second estimated phase error (φ_{FF}).

3. The phase error compensation arrangement of claim 2, wherein the filter includes a low-pass filter, in particular a moving average filter.

4. The phase error compensation arrangement of claim 2, wherein the filter includes equal weights for the output values of the phase determiner.

5. The phase error compensation arrangement of claim 3, wherein the filter includes equal weights for the output values of the phase determiner.

6. The phase error compensation arrangement of claim 1, wherein the phase shifter includes a complex multiplier for multiplying a value of the phase shifted delayed receive signal with an error value, the error value being determined by a complex exponential function of the second estimated phase error (φ_{FF}).

7. The phase error compensation arrangement of claim 1, further configured to adapt a delay time of the delay element to a processing time of the phase error estimator.

8. The phase error compensation arrangement of claim 1, wherein the first phase error compensator is configured to determine phase error values based upon the value of the receive signal and the predefined pilot value at given times and to obtain the first estimated phase error (φ_{PS}) by interpolating between the phase error values.

9. The phase error compensation arrangement of claim 1, wherein a second slicer is arranged downstream of the second phase error compensator for mapping a value of a signal at an input of the second slicer onto a mapped value at an output of the second slicer, and including a feedback phase error compensator configured to:
obtain a feedback phase error (φ_{PLL}) based upon a difference value between the value at the input of the second slicer and the mapped value at the output of the second slicer; and
shift a phase of the receive signal by the feedback phase error (φ_{PLL}) to obtain the signal at the input of the second slicer.

10. The phase error compensation arrangement of claim 9, wherein the feedback phase error compensator includes a phase detector and a loop filter provided with the difference value to obtain the feedback phase error (φ_{PLL}).

11. The phase error compensation arrangement of claim 1, wherein another phase error compensator is arranged in cascade with the second phase error compensator, the another phase error compensator including another phase error estimator.

12. The phase error compensation arrangement of claim 11, wherein the another phase error compensator includes:
a delay element for delaying an input signal of the another phase error compensator, wherein the another phase error estimator provides another estimated phase error (φ_{FF2}, φ_{FFn}) of said input signal; and
a phase shifter for shifting a phase of the delayed input signal by the another estimated phase error (φ_{FF2}, φ_{FFn}).

13. The phase error compensation arrangement of claim 12, wherein the another phase error estimator comprises:
another slicer for mapping a value of said input signal onto a mapped value;
another conjugator for conjugating one of the mapped value and the value of said input signal to obtain another conjugated output and another unprocessed output;
another multiplier for multiplying the another conjugated output and the another unprocessed output of the another conjugator to obtain another distinction value; and
another phase determiner for determining a phase of the another distinction value to obtain the another estimated phase error (φ_{FF2}, φ_{FFn}).

14. A phase error compensation method for compensating a phase error of a receive signal, the phase error estimation method comprising:
obtaining a first estimated phase error (φ_{PS}) of the receive signal based on a value of the receive signal and a predefined pilot value;
shifting a phase of the receive signal by the first estimated phase error (φ_{PS});
mapping a value of the phase shifted receive signal onto a mapped value;
conjugating one of the mapped value and the value of the phase shifted receive signal to obtain a conjugated output value and an unprocessed output value;
multiplying the conjugated output value and the unprocessed output value to obtain a distinction value;
determining a phase of the distinction value to obtain a second estimated phase error (φ_{FF});
delaying the phase shifted receive signal; and
shifting a phase of the delayed phase shifted receive signal by the second estimated phase error (φ_{FF}).

15. The method of claim 14, wherein obtaining the second estimated phase error (φ_{FF}) includes filtering the distinction value.
